(19) United States
(12) Patent Application Publication
(10) Pub. No.: US 2004/0006839 A1
(43) Pub. Date: Jan. 15, 2004

(54) Heated windshield wiper assembly

(76) Inventor: Leland A. Samson, Valley City, ND (US)

Correspondence Address: Anthony G. Eggink, Anthony G. Eggink & Associates, 3100 First National Bank Building, 332 Minnesota Street, Saint Paul, MN, 55101, US

(21) Appl. No.: 10/612,855

(22) Filed: Jul. 3, 2003

Related U.S. Application Data
(60) Provisional application No. 60/395,044, filed on Jul. 10, 2002.

(51) Int. Cl. B60S 1/38

(52) U.S. Cl. 15/250.06; 219/202

(57) ABSTRACT

A heated windshield wiper assembly having a frame structure, a blade member having a heating element positioned therein and an electrical connection structure to electrically connect the assembly to the power source of a vehicle. A thermostat is interconnected in the electrical connection structure and positioned on the wiper arm of the vehicle. The heating element is positioned within a bore of the blade member and is automatically activated when the thermostat senses a predetermined temperature near and above freezing. The heated windshield wiper assembly of the invention provides increased visibility to the driver of a vehicle during harsh winter conditions because snow and ice buildup is lessened or eliminated by the wiper assembly. The assembly is constructed so that various parts and elements of the wiper assembly are easily removable, so that replacement can be easily accomplished.

### BACKGROUND OF THE INVENTION

This application claims the benefit of U.S. Provisional Patent Application No. 60/395,044, filed on Jul. 10, 2002.

This invention relates generally to a heated windshield wiper assembly. Particularly, this invention relates to a windshield wiper assembly for vehicles and which is constructed and arranged to heat the windshield wipers to prevent snow and ice from accumulating on the vehicle's wiper blades and thus the windshield of the vehicle.

The heated wiper blade assembly of the invention may be installed and utilized on vehicles as an aftermarket assembly or may be provided and incorporated into a vehicle by the original equipment manufacturer.

As is known, driving in winter conditions can be dangerous. During severe winter conditions, snow may fall so quickly that a vehicle's windshield wipers can do very little to prevent build-up of snow and ice on the wiper blades and the windshield. The windshield wiper assemblies of this invention provide a heated wiper blade which prevents build-up of snow and ice on the wiper blades to increase the driver's visibility. The wiper assemblies of the present invention are controlled by a thermostat which automatically activates in a predetermined temperature range. Although heated when freezing conditions exist, the wiper assemblies of the invention are designed for year round use. The wiper assemblies may be constructed and arranged in a range of sizes for use on many vehicles which require wiper blades, for example, trucks, school buses, transit buses, pickups, cars, SUV's, construction equipment, and the like.

Although prior art wiper assemblies are known, they exhibit many difficulties and limitations. For example, prior art assemblies typically do not provide ease of replacement of parts and are often complex in structure and difficult to install. For example, if one part or element of a prior art assembly fails, the entire assembly may need to be replaced. In the assembly of the present invention, the wiper blade and the heating element positioned in the blade member are easily replaceable and the electrical connecting parts of the assembly are also easily separable and replaceable. Thus, the entire assembly does not have to be replaced when only the heating element is defective, for example. Other prior art devices include thermostats which are not located in effective operating positions and are often an integral and inseparable part of the electrical control assembly. The thermostat element of the present invention is positioned in the assembly at an effective location with respect to potential ice and snow buildup on the windshield and can therefore properly, effectively and efficiently read the temperature and to thereby activate the heating element when required.

Other prior art heated windshield wiper assemblies may also provide inefficient heat transfer designs. The assembly of the present invention utilizes a novel wiper blade configuration with an effective heating element structure which provides an efficient and effective heat transfer design for melting and clearing snow and ice buildup from a vehicle's wiper blade and thus the windshield of the vehicle. The windshield wiper assembly of the present invention overcomes the problems and limitations of the prior art and provides an efficient, economical and user friendly assembly that provides for easy installation, use and maintenance.

### SUMMARY OF THE INVENTION

The heated windshield wiper assembly of the present invention comprises a frame structure, a blade member, a heating element and an electrical connection structure. The frame structure is adapted for connection to the wiper arm of a vehicle and to support and hold the wiper blade onto a vehicle windshield. The blade member body is preferably made of a silicone rubber composition or a like material and has a tubular aperture or bore extending along the length of the blade body. The tubular aperture is constructed and arranged to contain the heating element which generates and conducts heat throughout the blade member body.

The assembly has an electrical connection structure interconnecting the heating element in the blade member to a power source, such as to the power controlled by the ignition of the vehicle. The electrical connection structure includes positive and negative wires which extend to the heating element in the blade member and a portion of the wiring is attached to the wiper arm frame structure. For example, insulated wires may be fastened to the blade frame structure by means of nylon ties or like fasteners. The wiring is preferably protected by a flexible sheath or jacket. A thermostat device, i.e., a bimetal thermostat or the like, is electrically interconnected with the heating element so that the outside temperature is measured to activate the heating element at a predetermined temperature, for example between a range of 37-40° F. The thermostat device is preferably attached to the wiper arm of the vehicle so that its temperature readings are accurate and effective because of its proximity to the environment of the windshield and blade assembly. The electrical wiring extends under the hood, or through the firewall of a vehicle, for example, for connection to the electrical system of the vehicle. A fuse is provided to protect the vehicle electrical system from the operation of the heated wiper assembly. Preferably, one of the fuse wires contains a butt connector for ease of installation. The positive (red) wire is connected to the fuse and the negative (black) wire is connected to ground. The fuse is preferably interconnected to the vehicle's “ignition-on” wire.

The wiper assembly is constructed and arranged to be easily separable, so when one part or element of the assembly needs maintenance or replacement, it can easily be detached and the entire assembly need not be replaced. For example, the heating element and wiper blades are designed to be easily removable and replaceable. In summary, the wiper assembly of the invention is easy to install, use, and maintain.

An object of the invention is to provide a wiper assembly having a novel wiper blade member and cooperating heating element which increases driver visibility for safety during harsh winter conditions and which provides a wiper assembly that can also be used as an all-season wiper blade system.

The wiper assembly of the present invention is an efficient and effective assembly due to the positioning of the thermostat. The thermostat is preferably positioned on the wiper arm of the vehicle so that it is close to the windshield and can accurately and efficiently measure the temperature and thereby activate the heating element when weather conditions require activation.

These and other benefits of this invention will become clear from the following description by reference to the drawings.

### DESCRIPTION OF THE DRAWINGS

FIG. 1 is a plan view showing the various parts or elements of the heated windshield wiper assembly of the present invention;

FIG. 2 is a plan view of the wiper assembly of the present invention in an assembled state and shown in use with a vehicle;

FIG. 3 is a sectional view of the wiper blade member of the assembly of the present invention.

FIG. 4 is a sectional view of the top of the wiper blade member of the assembly of the present invention.

FIG. 5 is a lateral sectional view of a portion of the wiper blade member of the assembly of the present invention.

FIG. 6 is a plan view of the heating element of the assembly of the invention;

FIG. 7 is a sectional view of the wiper blade member of the assembly of the present invention showing an alternate embodiment of the bore in the blade member of the present invention;

FIG. 8 is a sectional view of another embodiment of the bore in the blade member of the present invention;

FIG. 9 is a sectional view of another embodiment of the bore in the blade member of the present invention;

FIG. 10 is a sectional view of a further embodiment of the bore in the blade member of the present invention;

FIG. 11 is a sectional view of another embodiment of the bore in the blade member of the present invention; and

FIG. 12 is a perspective view showing the universal adapter structure used to attach the heated wiper assembly to a wiper arm of a vehicle.

### DESCRIPTION OF THE PREFERRED EMBODIMENTS

The heated wiper blade assembly of the invention may be installed and utilized on vehicles as an aftermarket item or may be provided and incorporated into a vehicle by the original equipment manufacturer (OEM).

The heated wiper assembly 10 shown and described herein is directed for use as an aftermarket assembly. The electrical wiring connection structure may be readily changed and incorporated into the vehicle by an OEM. For example, portions of the wiring structure and thermostat may be incorporated into the wiper arm, thereby altering the need for fasteners, and the fuse and connection to the vehicle power source may also be readily changed and incorporated into the electrical system by the OEM. The blade structure and cooperating heating element would generally be the same in both installations.

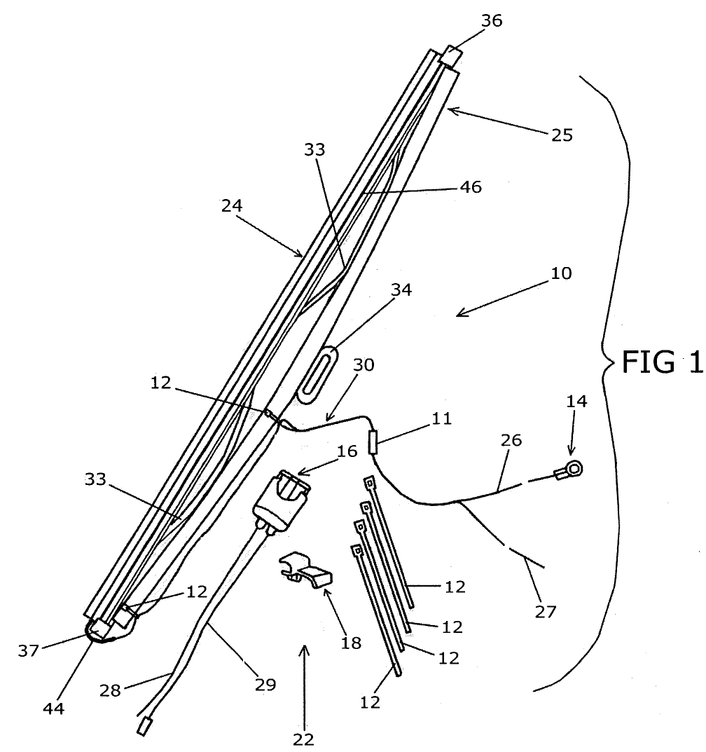

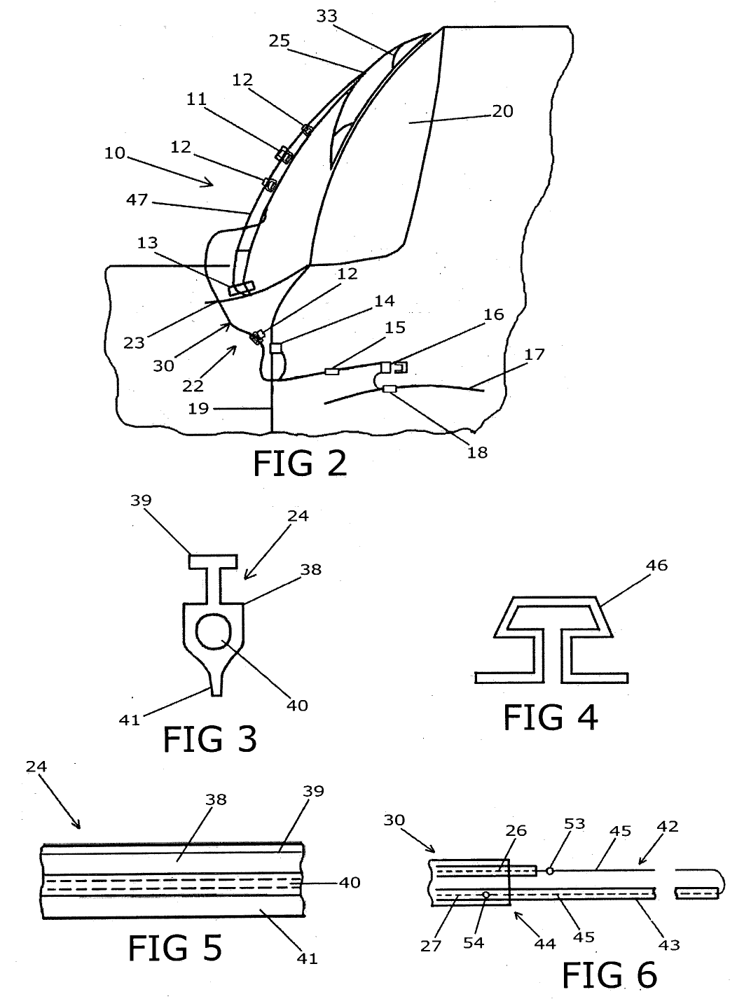

FIGS. 1 and 2 show the various parts and elements of the heated windshield wiper assembly of the present invention. The heated wiper assembly 10 is shown to have a number of parts which form an aftermarket assembly that may be provided in the marketplace for use by consumers on existing vehicles. However, the assembly may also be incorporated into a vehicle by the original equipment manufacturer, thereby utilizing only a number of the elements shown.

The heated wiper assembly 10 is shown comprised of a blade member 24 held to blade support 46 that is connected to a wiper frame structure 25. The blade member 24 has a heating element which is connected to an electrical connection structure 22 that extends to the power source of the vehicle. The wiper frame structure 25 mounts to the vehicle's wiper arm 47 which pivots, permitting the blade member 24 to wipe the surface of a vehicle windshield 20. Various adapter structures, such as a TRI adapter or a universal adapter 31, as shown in FIG. 12, are provided for attaching the frame structure 25 to the vehicle's wiper arm 47. The frame structure 25 is shown to have a plurality of spring members 33 which provide a resilient force to the wiper blade member 24 for uniform contact with the windshield. Although two spring members 33 are shown in FIGS. 1 and 2, any number of spring members or other means may be utilized for the frame structure, as is known in the art.

Referring further to FIGS. 1-6, the blade member 24 has a tubular aperture or bore 40 which contains a heating element that extends along the length of blade member 24 and is frictionally held therein. The heating element terminates near the end of blade member 24 and is connected to electrical connection structure 22, namely, to the negative (black) wire 26 and to the positive (red) wire 27 which are contained in insulated jacket or casing 30. In FIG. 1, the negative wire 26 is also shown having a ring connector 14 at its end for connection to ground. The connecting wiring 26 and 27 in casing or jacket 30 begins at the end of the blade structure, curves around, and extends along the frame structure 25 and wiper arm 47. A thermostat device 11, which activates at a predetermined temperature, is shown interconnected and contained in the casing 30 of the connecting wiring 22. Fastening members 12 such as nylon ties or the like, are shown and which are provided for attaching the wires of the heating element to various parts of the vehicle, although other fastening devices may be used. For example, when installing the assembly, a nylon tie 12 is preferably placed on either side of the thermostat 11 to keep it in place on the vehicle's wiper arm 47. A fuse 16, i.e., 5 amp, is shown having a holder and fuse wires 28 and 29 extending therefrom. Preferably, fuse wire 29 terminates at a butt connector. Tap connector 18 is shown and is provided for attachment of the other fuse wire 28 to the vehicle “ignition on” wire.

An insulated casing or jacket 30 contains and protects wires 26 and 27 and thermostat 11 and is preferably constructed of low temperature polyvinylchloride (PVC) tubing or the like which retains its flexibility in freezing temperatures. Jacket 30 can be wrapped about the wires via a shrink wrap process, for example. Negative wire 26 and positive wire 27 are also preferably coated with low temperature PVC or the like so that they retain flexibility in freezing temperatures. Thermostat device 11 is preferably a bimetal thermostat which activates the heating element at a temperature range of approximately 37-40° F.±3° F. Thermostat 11 may be welded for connection to wires 26 and 27 and a protective coating is preferably applied to the weld connection to prevent subsequent corrosion.

FIG. 3 shows a sectional end view of the blade member 24, FIG. 5 shows a lateral view of blade member 24 and FIG. 6 shows a plan view of the heating element 42 which is positioned in the bore 40 of blade member 24. Specifically, blade member 24 is shown to have a blade body 38 which is preferably constructed of silicone rubber or a like composition. Silicone rubber is preferred because silicone retains flexibility and performance through exposure to ozone, ultraviolet rays, washer fluid, road grime, ice and snow and through temperatures from −100° F. to 350° F. Thus silicone rubber can withstand high temperatures, for example, due to the weather or the heat from the heating element. Prior art windshield wipers made of natural rubber or silicone mixtures may lose functional performance below 32° F. and above 110° F. and may have been found to rapidly deteriorate, dry, crack, or break down and streak the windshield.

Referring to FIGS. 3 and 4 blade body 38 is shown having a generally cross-sectional T-shaped top portion 39 which permits the blade member 24 to be secured in the mating blade support 24 of frame 25 which in FIG. 1 is shown to have end clips 36 and 37. Clips 36 and 37 which attach to the ends of frame 25 permit the blade body 38 to be removed from the blade support 46, shown in FIG. 4, for installation and/or replacement. The blade body 38 is further shown to have a generally V-shaped bottom portion 41 which engages the windshield of a vehicle. The blade member body 38 has a configuration that permits the assembly to evenly conduct or dissipate the heat provided by heating element 42 in bore 40.

The configuration of the blade member 24 also permits ease of manufacture and allows the extruded body length to be cut to any desired length. For example, a plurality of wiper assembly sizes, i.e., at least six, may be provided for installation to meet the requirements of a variety of vehicles and windshield designs. For example, the blade members 21 may be provided in lengths of approximately 16, 18, 20, 22, 24, and 28 inches.

Referring to FIGS. 5 and 6, blade body 38 is shown to have an elongated bore 40 wherein the heating element 42 is positioned. The heating element 42 is shown comprised of an elongated heating wire 45 which is partially looped through an insulated tube or sheath 43. Positive wire 27 and negative wire 26 are contained within insulated casing 30 for electrical connection to the vehicle's power source. Heating element 42 is shown connected to the positive wire 27 at connection 54 and negative wire 26 at connection 53. Connections 53 and 54 may be made by a welding process, for example. Further, a protective coating is preferably applied to the welded connections to thereby prevent corrosion. The sheath 43 is preferably made of polytetrafluoroethylene (PTFE) tubing or the like and the elongated heating wire 45 is preferably constructed of nickel chrome composition wire or other wire compositions exhibiting the required resistivity. The elongated heating wire 45 has a predetermined resistance and essentially extends through the length of bore 40 and loops or returns through insulated tube 43. The resistance may be controlled by the thickness or diameter of the wire utilized. The electrical current through wire 45 causes its resistance to generate heat and to thereby heat the wiper body 38. The resistance provided by the heating element wire 45 varies depending on the length of the blade, for example the resistances for 16, 18, 20, 22, 24, and 28 inch blades may be approximately 9.4, 6.6, 6.6, 3.8, 3.8, and 2.9 Ohm/ft, respectively. The insulated tube 43 and heating wire 45 have an overall thickness to be frictionally held and, thus, separable from the elongated bore 40. Should the wire 45 of the heating element 42 break, for example, only the heating element 42 and the wiring harness connected thereto needs to be replaced, for example, rather than the entire blade member or assembly.

The positioning of the heating element 42 in bore 40 and the uniformly configured body 38 of the blade member 24 provide efficient heat conduction through the blade member body. It has been found that bore 40 provides the blade member 24 with more flex and bend to conform to a curved windshield and thus provides a better squeegee or wiping function. Thus the heating element 42 is preferably not positioned tightly in bore 40, instead space should be available to permit the blade member 24 to conform to a curved windshield and to effectively clear the windshield surface. Although shown to have a circular cross-section 40 in FIG. 3, the bore may have other cross-sectional profiles, for example, diamond, rectangular, oval, triangular, square, polygonal, and other shapes.

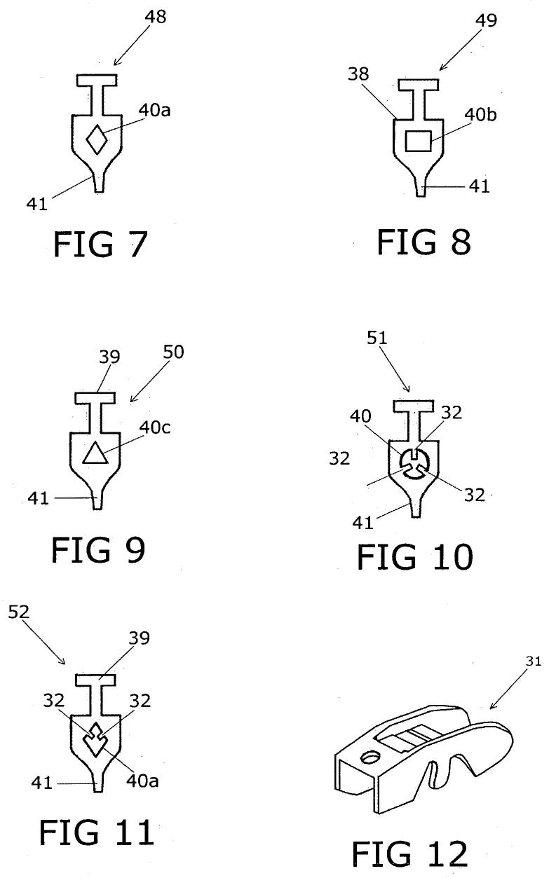

For example, FIG. 7 show the blade member 48 having a bore 40a having a diamond cross-section, FIG. 8 shows blade member 49 having a bore 40b with a square or rectangular cross-section and FIG. 9 shows blade member 50 having a bore 40c with a triangular cross-section. The heating element 42 is positioned into these elongated channels or bores as described with respect to FIGS. 3, 5 and 6. As further shown in FIGS. 10 and 11, the bore of the blade body may also have at least one leg or rib structure 32 therein to both hold the heating element and to provide heat transfer through the wiper body. The rib or ribs preferably are elongated and extend into and along the length of the bore and may be extruded during the manufacturing process of making the silicone rubber blades. The leg(s) are constructed and arranged to provide contact between the blade body and the heating element 42. This direct contact facilitates the conduction of heat from the heating element to the blade body member and thus effectively heats the blade member body. The contact further maintains the free space within the bore so the blade member can bend and conform to the windshield to effectively clear the windshield surface. Specifically, FIGS. 10 and 11 respectively show blade member 51 having a circular bore 40 and blade member 52 having a diamond-shaped bore 40a, and each having leg or rib structures 32 extending into the bore. Any of the bores in the blade bodies of FIGS. 3 and 7-11 may have one or more leg or rib structures protruding into the bore to thereby aid in securing the heating element and to dissipate the heat generated through the entire blade body structure.

To install the wiper assembly 10 onto a vehicle as an aftermarket assembly, the vehicle's existing wiper frame and blade is first removed from the wiper arm. Next, the frame structure 25 of the wiper assembly 10, is mounted to the wiper arm of the vehicle. FIG. 12 shows a universal adapter 31 which fits most vehicle wiper arms and permits the frame structure to be attached to the vehicle wiper arm. As is known, other methods of mounting the frame structure 25 of the wiper assembly 10 to the vehicle can be utilized based on the type of vehicle wiper arm and the type of adapter needed for use with the wiper arm. For example, a universal adapter, a B Adapter, a Q adapter, a Side Saddle Adapter, a Variable Adapter M4, or a TR1 Adapter, as known in the art may be used for this purpose. The latter adapter is typically used in connection with school buses.

Referring to FIG. 2, after the frame structure 25 is mounted to the vehicle pivot arm 13 using the proper adapter, the electrical connection structure 22 is connected to the vehicle power source. The wiring in casing 30 connected to and extending from the heating element 42 is run down the wiper arm and through the vehicle's wiper hole 23, if present, and enough slack should be left in the wires so that the wiper performance is not impeded. Nylon ties 12 are placed around the wiper arm to keep the casing 30 and the thermostat 11 in place. The wires are then fed under the hood or through the firewall 19, leaving slack in the pivot area 13.

Referring to FIGS. 1 and 2, the wiring in casing 30 is run along the under side of the wiper arm 47 and the wiring preferably come out from under the wiper about two inches from the pivot 13. A nylon tie 12 is preferably positioned on either side of the thermostat 11 to keep it in place on the wiper arm 47. The wiring preferably arcs above the pivot 13 by about 0.5 inches and then the wiring preferably curves down in a steep manner for entry into the engine compartment through an aperture in the cowl 23 about 1.5 inches behind the pivot point in line with the midpoint of the wiper path.

Next, fuse wire 29 with the butt connector 15 is connected to the positive red wire 27 of the wiring. Fuse wire 28 is then connected using a tap connector 18 to the vehicle's “ignition on” wire 17. The ring connector 14 of the negative black wire 26 from the casing 30 is then connected to a proper ground.

In summary, the heated wiper assembly 10 of the present invention replaces a vehicle's existing wiper blade and frame in order to improve a driver's visibility during winter conditions. The heated wiper assembly may be provided as an aftermarket assembly or provided as original equipment on a vehicle. The wiper assembly 10 is constructed and arranged to be easily connected to the electrical system of a vehicle. The wiper assembly can be used during all seasons of the year because the thermostat senses the temperature and only activates the heating element when it senses a predetermined temperature near and above freezing. Each element of the assembly may be constructed to be easily removable, for example the heating element and the blade member. The wiper blade is preferably made of a silicone rubber composition which typically lasts three times longer than other wiper blades. Thus, if, for example, the heating element fails or wears out, only that element along with any wiring attachments may be replaced without removing and replacing the whole assembly. The wiper assembly draws approximately up to 1.3 Amps per blade and is intended for use in 12V systems. The wiper assembly of the invention is constructed and arranged to be used with any vehicle that has wiper blades, for example, trucks, cars, vans, buses, pickups, SUV's, and construction equipment.

As many changes are possible to the heated wiper assemblies of this invention, utilizing the teachings thereof, the description above and the accompanying drawings should be interpreted in the illustrative and not in the limited sense.

That which is claimed is:

1. A heated windshield wiper assembly comprising:
a) a frame structure for connection to the wiper arm of a vehicle, said frame structure having an elongated blade support member;
b) a blade member having a tubular bore extending along its length and having a top portion for insertion into said blade support member;
c) a heating element positioned in said tubular bore of said blade member; and
d) an electrical connection structure connected to said heating element and having means for connecting to the power source of the vehicle, said electrical connection structure having a thermostat for activating said heating element.

2. The heated windshield wiper assembly of claim 1, wherein said tubular bore of said blade member has a cross-sectional configuration selected from the group of configurations consisting of a circle, a diamond, rectangle, oval, triangle, square and a polygon.

3. The heated windshield wiper assembly of claim 2, wherein said tubular bore has at least one elongated leg member extending outwardly therein for engaging and securing said heating element.

4. The heated windshield wiper assembly of claim 3, wherein said heating element is comprised of a nonconductive sheath and an elongated flexible wire looped therethrough said flexible wire having a predetermined resistance.

5. The heated windshield wiper assembly of claim 4, wherein said blade member is constructed of silicone rubber and wherein said heating element is frictionally held within said tubular bore.

6. The heated windshield wiper assembly of claim 1, wherein said frame structure further comprises a wiper arm and wherein said thermostat is attached thereto.

7. The heated windshield wiper assembly of claim 1, wherein said thermostat is a bimetal thermostat having an activation temperature between 34-43° F.

8. The heated windshield wiper assembly of claim 1, further comprising a fuse device, a plurality of tie-down members, connecting wires, a ring connector, a butt connector and a tap connector, utilized for an aftermarket wiper assembly structure.

9. The heated windshield wiper assembly of claim 8, wherein said fuse is a five amp fuse, wherein said heating element is constructed of a nickel chrome composition to heat said blade member in a temperature range of approximately 100-350° F., wherein said electrical connection structure further comprises a polymeric sheathing, wherein said blade members have a length ranging from 16 to 28 inches and wherein an adapter device is provided for connecting said frame structure to the wiper arm of a vehicle.

10. A heated windshield wiper assembly comprising:
a) a blade member, said blade member having a bore therein and a predetermined configuration;
b) a frame structure constructed and arranged to releasably receive said blade member;
c) a heating element constructed and arranged to fit into said bore in said blade member;
d) a thermostat device constructed and arranged to read the ambient temperature and activate said heating element at a predetermined temperature; and
e) an electrical connection structure incorporating said thermostat device therein, wherein said electrical connection structure is constructed and arranged to connect said assembly to the electrical system of the vehicle and wherein said electrical connection structure is constructed and arranged to be connected to said heating element.

11. The heated windshield wiper assembly of claim 10, wherein said predetermined configuration of said blade member comprises a cross-section having a T-shaped top portion and a V-shaped bottom portion, wherein said T-shaped top portion is constructed and arranged to be matingly and releasably attached to said frame structure.

12. The heated windshield wiper assembly of claim 10, wherein said bore of said blade member has a cross sectional configuration selected from the group of cross-sectional configurations consisting of circular, diamond, rectangular, oval, triangular, square, and polygonal.

13. The heated windshield wiper assembly of claim 10, wherein said thermostat device is a bimetal thermostat and wherein said predetermined temperature at which said thermostat device activates said heating element is a range of approximately 37-40° F.±+3° F.

14. The heated windshield wiper assembly of claim 10, wherein said blade member is made of a silicone rubber composition.

15. The heated windshield wiper assembly of claim 10, wherein said heating element is comprised of a wire and an insulative protective sheath.

16. The heated windshield wiper assembly of claim 15, wherein said wire is made of nickel chromium and said protective sheath is made of PTFE.

17. A heated wiper assembly for a vehicle having a wiper arm, comprising:
a) a blade body member held to a blade support, said blade body member having a top portion and a bottom wiper portion, said top portion being T-shaped for matingly fitting with said blade support and said bottom wiper portion being V-shaped and containing an elongated tubular aperture;
b) a heating element for placement in said elongated tubular aperture, wherein said heating element is comprised of a heating wire and a protective sheath;
c) a frame structure for mounting to the vehicle's wiper arm, wherein said frame structure is in communication with said blade support;
d) an adapter structure for attaching the frame structure to the wiper arm; and
e) an electrical connection structure for electrical connection of said assembly to said vehicle, said electrical connection structure including a thermostat device that activates said heating element at a predetermined temperature.

18. The heated wiper assembly of claim 17, wherein said elongated tubular aperture contains at least one rib member.

19. The heated wiper assembly of claim 17, wherein said elongated tubular aperture has a cross sectional configuration selected from the group of cross-sectional configurations consisting of circular, diamond, rectangular, oval, triangular, square, and polygonal.

20. The heated wiper assembly of claim 17, wherein said blade body member is made of silicone rubber.

21. The heated wiper assembly of claim 17, wherein said protective sheath is made of PTFE tubing and said heating wire is made of nickel chrome wire.

22. The heated wiper assembly of claim 17, wherein said thermostat device is a bimetal thermostat and wherein said predetermined temperature at which said thermostat device activates said heating element is approximately 37-40° F.±+3° F.

23. The heated wiper assembly of claim 17, wherein said assembly further comprises a fastening device for attaching wires of the heating element to various parts of the vehicle.
